(19) United States
(12) Patent Application Publication
(10) Pub. No.: US 2008/0313563 A1
(43) Pub. Date: Dec. 18, 2008

(54) METHOD AND APPARATUS FOR CREATING MAP TEMPLATE AND METHOD AND APPARATUS FOR MANAGING DEVICES USING MAP TEMPLATE

(75) Inventor: Eun-kyung YUN, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/100,593

(22) Filed: Apr. 10, 2008

(30) Foreign Application Priority Data
Jun. 14, 2007 (KR) 2007-58582

(51) Int. Cl. G06F 3/048

(52) U.S. Cl. 715/810

(57) ABSTRACT

A method and apparatus to create a map template, and a method and apparatus to manage devices using a map template, the method of managing the devices using the map template including: searching for one or more devices to be managed; selecting a map template that represents an interior structure of a building in which the one or more found devices are located; and arranging the one or more found devices at predetermined positions in the selected map template. Thus, a user can easily manage positions of the devices without any need to upload or edit a map image by using the map template that the user creates or selects as desired.

### CROSS-REFERENCE TO RELATED APPLICATION

This application claims the benefit of Korean Application No. 2007-58582, filed Jun. 14, 2007, in the Korean Intellectual Property Office, the disclosure of which is incorporated herein by reference.

### BACKGROUND OF THE INVENTION

1. Field of the Invention

Aspects of the present invention relate to a method and an apparatus to manage a plurality of devices, and more particularly to, a method and an apparatus to manage location information of a plurality of devices.

2. Description of the Related Art

Generally, to manage devices located in a building, a map that shows the interior structure of the building is used. When a conventional device management tool arranges devices into groups using a device map function, the tool uploads map image files for individual groups of devices to a management server so that location information of the devices can be provided. The management server stores map image files and includes a database storing information of devices. Thus, conventionally, to manage the devices, the image files (such as a map of the structure of the building where the devices are located) must be uploaded to a management server. Alternatively, an image file may be used by simplifying a structural drawing of the building. However, it is difficult to obtain image files such as a structural diagram of the building where devices are located. Furthermore, even if such image files are obtained, since the structural drawing is similar to a plan of a building that is complicated to look at, it is inconvenient to use the structural drawing for the purpose of managing devices. Also, to use a map image by simplifying the structural drawing, a substantial amount of time to edit images is required. Moreover, image files for devices are required to be uploaded to a management server every time the devices are managed.

### SUMMARY OF THE INVENTION

Aspects of the present invention provide a method and an apparatus to create a map template that represents a structure of a building in which devices are located, by using an application that manages the devices. In particular, aspects of the present invention provide a method and apparatus to create a map template without uploading or editing a map image. Aspects of the present invention further provide a method and apparatus to manage one or more devices using a map template, such that a user can easily manage the positions of the devices without any effort of uploading or editing a map image by using a map template that the user creates as desired.

According to an aspect of the present invention, there is provided a method of creating a map template that represents an interior structure of a building in which devices are located, the method including: displaying a menu of an application that manages the devices, the menu including a plurality of elements selectable to represent interior components of a general building; displaying a user interface in the application, the user interface displaying a representation of the interior structure of the building in which the devices are located; selecting one or more elements from the displayed menu to compose, in the user interface, the interior structure of the building in which the devices are located; and arranging the selected elements at positions in the displayed user interface to correspond to the interior structure of the building.

According to another aspect of the present invention, there is provided an apparatus to create a map template that represents an interior structure of a building in which devices are located, the apparatus including: a display unit to display a menu window of an application that manages the devices, the menu window including a plurality of elements selectable to represent interior components of a general building, and to display a user interface in the application, the user interface displaying a representation of the interior structure of the building in which the devices are located; and a map template creating unit to select one or more elements from the displayed menu window to compose, in the user interface, the interior structure of the building in which the device are located, and to arrange the selected elements at positions in the displayed user interface in order to create the map template to correspond to the interior structure of the building.

According to still another aspect of the present invention, there is provided a method of managing devices located in a building using a map template, the method including: searching for one or more devices to be managed in the building; selecting a map template that represents an interior structure of the building in which the one or more found devices are located; and arranging the one or more found devices at predetermined positions in the map template.

According to yet another aspect of the present invention, there is provided a computer readable recording medium having embodied thereon a computer program for executing the method of managing devices using a map template.

According to another aspect of the present invention, there is provided an apparatus to manage devices located in a building using a map template, the apparatus including: a searching unit to search for one or more devices to be managed in the building; a map template selecting unit to select a map template that represents an interior structure of the building in which the one or more found devices are located; and a device managing unit to arrange the one or more found devices at predetermined positions in the selected map template.

According to another aspect of the present invention, there is provided a method of managing devices located in a building using a map template, the method including: searching for one or more devices in the building to be managed; creating a map template that represents an interior structure of the building in which the found one or more devices are located; and arranging the one or more found devices at predetermined positions in the selected map template.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus to create a map template according to an embodiment of the present invention;

FIG. 2 illustrates a screen that is displayed on a display unit of the apparatus of FIG. 1 according to an embodiment of the present invention;

FIG. 3 illustrates a map template that is created according to an embodiment of the present invention;

FIG. 4 is a flowchart illustrating a method of creating a map template according to an embodiment of the present invention;

FIG. 5 is a flowchart illustrating a method of managing devices using a map template according to an embodiment of the present invention; and

FIG. 6 is a block diagram of an apparatus to manage devices using a map template according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

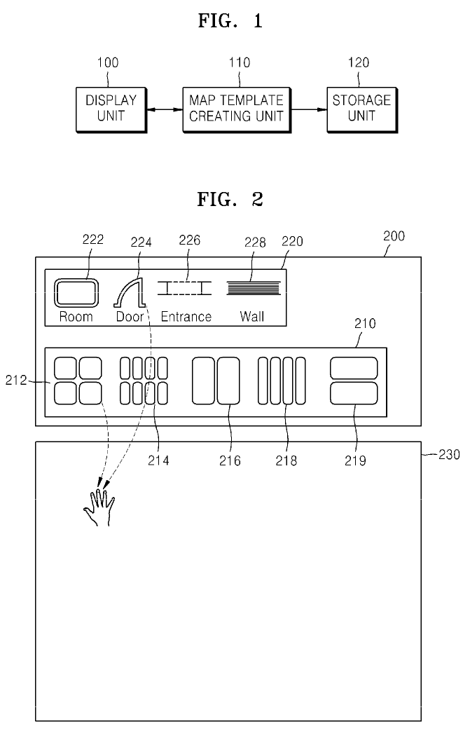

FIG. 1 is a block diagram of an apparatus to create a map template according to an embodiment of the present invention. Referring to FIG. 1, the apparatus to create a map template includes a display unit 100, a map template creating unit 110, and a storage unit 120.

The display unit 100 includes a menu window that has a plurality of elements used to display the inner structure of a building. Furthermore, the display unit 100 includes a user interface for the structure of a specific building where devices are located.

FIG. 2 illustrates a screen that is displayed on the display unit 100 of the apparatus of FIG. 1 according to an embodiment of the present invention. Referring to FIG. 2, the display unit 100 displays a menu window 200 and a user interface 230.

The menu window 200 includes a layout menu 210 and a figure image menu 220. Furthermore, the layout menu 210 includes a plurality of layouts that partition the inner space of the building. That is, the layout menu 210 includes layouts, each of which partitions the building into several areas. For example, layouts 216 and 219 each partition the building into two areas, layouts 212 and 218 partition the building into four areas, and layout 214 partitions the building into eight areas. The figure image menu 220 includes a variety of figure images that represent the interior components of the building, such as a room image 222, a door image 224, an entrance image 226, and a wall image 228. The layouts 212, 214, 216, 218, and 219 and the figure images 222, 224, 226, and 228 are displayed as icons.

The user interface 230 displays the interior structure of the building that a user wants to arrange. In other words, when the user wants to arrange the structure of a specific building where devices are located, the user interface 230 shows the structure of the building arranged by the user.

Referring to FIG. 1, the map template creating unit 110 selects the layout 212, 214, 216, 218, or 219 and figure images 222, 224, 226, or 228 corresponding to the interior structure of the building from the menu window 200 in FIG. 2. Then, the map template creating unit 110 arranges the selected layout 212, 214, 216, 218, or 219 and figure images 222, 224, 226, or 228 at particular positions of the user interface 230 to create a desired map template that represents the interior a of the building. Generally, the structure of the building may be shown using a layout 212, 214, 216, 218, and 219 that partitions the space into several areas, and figure images 222, 224, 226, and 228 such as a door 224, an entrance 226, etc. Thus, the layout 212, 214, 216, 218, and 219 and the figure images 222, 224, 226, and 228 are selected from the layout menu 210 and the figure image menu 220 in the menu window 200 to display the desired structure of the building, and are arranged in the user interface 230 appropriately. Since the layout 212, 214, 216, 218, and 219 and the figure images 222, 224, 226, and 228 are displayed as icons, the layout 212, 214, 216, 218, and 219 and the figure images 222, 224, 226, or 228 can be selected by means of a drag-and-drop method and be arranged in appropriate positions of the user interface 230. Since the structure of the general building may be defined in this manner, the created interior structure of the building is referred to as a map template. FIG. 3 illustrates a map template that is created according to an embodiment of the present invention. Referring to FIG. 3, the map template that represents the structure of the building using the layout 212, 214, 216, 218, and 219 and figure images 222, 224, 226, and 228 can be created by the map template creating unit 110 in FIG. 2.

Referring back to FIG. 1, the storage unit 120 receives the created map template from the map template creating unit 110 and stores the created map template. At this time, the storage unit 120 names the map template according to the general use of the map template. For example, when the created map template is used for a laboratory, the map template may be entitled “Laboratory,” and when the created map template is used for a conference room, the map template may be entitled “Conference Room.” That is, the created map templates can be stored in a database in this manner, and be used at any time when required. However, it is understood that, according to other aspects, the map template may be named by other methods and/or devices (such as named by a user).

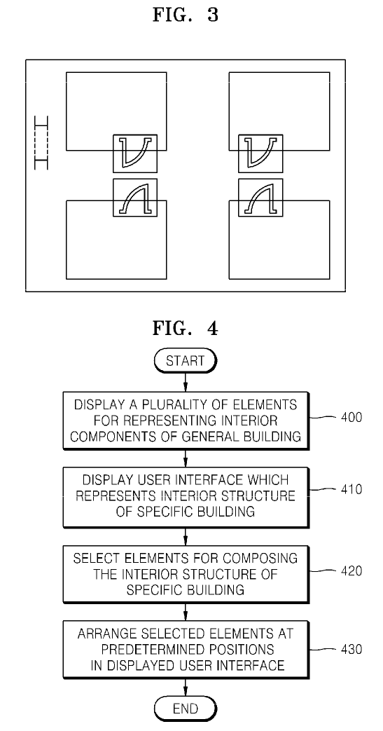

FIG. 4 is a flowchart illustrating a method of creating a map template according to an embodiment of the present invention. Referring to FIGS. 2 and 4, a plurality of elements are displayed to represent the interior structure of a building in operation 400. The elements include layouts 212, 214, 216, 218, and 219, each of which partitions the space of the building, and figure images 222, 224, 226, and 228 to present the interior structure of the building. The layout 212, 214, 216, 218, and 219 and figure images 222, 224, 226, and 228 may be displayed as icons in a menu window 200, as illustrated in FIG. 2.

A user interface 230 that shows the interior structure of a specific building is displayed in operation 410. The specific building is a building where devices are located. Specifically, when a user wants to arrange the structure of the building where the devices are located, the user interface shows a structure of a building corresponding to the building that the user wants.

Elements for the structure of the specific building are selected from the displayed elements in operation 420. For example, the elements, which are displayed as icons, may be selected using a mouse.

The selected elements are arranged at particular positions of the user interface in operation 430. For example, the elements may be disposed at the positions using a mouse to create a map template for a desired structure of the specific building. However, it is understood that aspects of the present invention are not limited thereto. For example, the elements may be selected and disposed using a touch screen. The created map template may be as illustrated in FIG. 3.

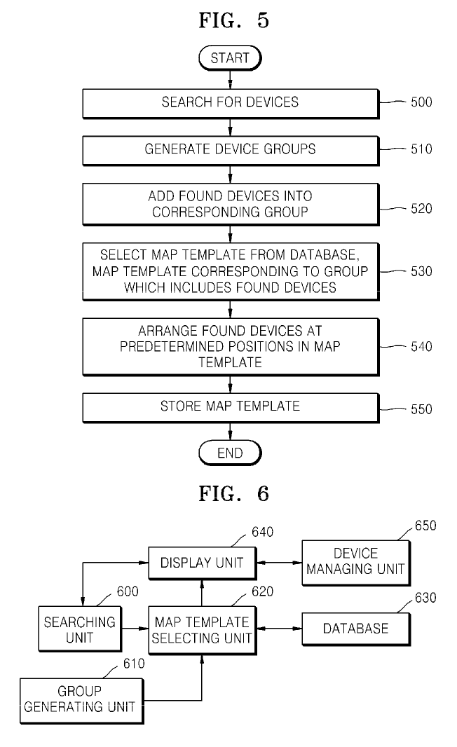

FIG. 5 is a flowchart illustrating a method of managing devices using a map template according to an embodiment of the present invention. Referring to FIG. 5, devices are searched for in operation 500. For example, an application that manages the devices executes a management tool, and searches for at least one or more devices using a search function of the management tool.

Device groups are generated in operation 510. The devices are grouped together based on a particular standard for management. For example, for companies, it is beneficial to classify the devices according to departments when managing the devices. Thus, the devices may be grouped together according to the departments in operation 510. Moreover, in the same department, the device groups may be categorized according to the places in which the devices are located (such as a conference room, a laboratory, a pantry, etc.).

Devices found as a result of the search (operation 500) are added to a corresponding device group in operation 520. That is, when the device groups are generated (operation 510), the devices that are found as a result of the search (operation 500) are added to the relevant device group. In other words, all the found devices are added individually to the corresponding groups so that the devices can be managed group-by-group.

A map template is selected from a database in operation 530. Specifically, the map template corresponds to one of device groups of which the corresponding found devices belong. To this end, a procedure for storing various kinds of map templates to the database may be performed beforehand. The map template is a template created by defining the structure of a building, and the device group created in operation 520 corresponds to the structure of the building. Hence, in operation 530, a map template that corresponds to the device group to which the found devices belong is selected from the map templates stored in the database. However, if the map template corresponding to the device group to which the found devices belong is not present in the database, a procedure of creating a map template may be additionally performed. The procedure of creating a map template is as illustrated in FIG. 4.

The found devices are arranged at certain positions of the selected map template in operation 540. Since the map template selected in operation 530 can be used as a desired interior structure of the building, the found devices are disposed at the positions of the map template that correspond to the positions of the structure of the building in which the found devices are located. Through this operation, the devices can be placed at the desired positions of the building.

The map template that includes the devices placed at the desired positions (operation 540) is stored in operation 550.

FIG. 6 is a block diagram of an apparatus to manage devices using a map template according to an embodiment of the present invention. Referring to FIG. 6, the apparatus to manage devices using a map template includes a searching unit 600, a group generating unit 610, a map template selecting unit 620, a database 630, a display unit 640, and a device managing unit 650.

The searching unit 600 searches for devices that are desired to be managed. For example, an application that manages devices executes a device management tool, and the searching unit 600 searches the display unit 640 for one or more devices by using a search function of the device management tool.

The group generating unit 610 produces groups of devices by grouping devices together based on a certain standard to manage the devices. For example, for companies, it is beneficial to classify the devices according to departments when managing the devices. Thus, the devices may be grouped together according to the departments. Moreover, in the same department, the device groups may be categorized according to the places where the devices are located (such as a conference room, a laboratory, a pantry, etc.).

The map template selecting unit 620 selects one or more map templates that show the structure of the building in which the devices found by the searching unit 600. The found devices are added into corresponding groups that are generated by the group generating unit 610, individually, and the map template selecting unit 620 selects a map template corresponding to one of the groups in which the relevant devices are included. Specifically, the database 630 stores a plurality of map templates, and the map template selecting unit 620 selects a map template that corresponds to the interior structure of the building in which the found devices are located by the searching unit 600. The devices that are included in the same group are located in the same building.

The display unit 640 displays the map template selected by the map template selecting unit 620.

The device management unit 650 arranges the found devices at certain positions of the selected map template. More specifically, when the display unit 640 displays the selected map template, the device management unit 650 disposes the devices at particular positions in the map template that correspond to the positions in the building in which the devices are located. When the map template is completed after arranging the devices, the map template is stored.

As described above, according to aspects of the present invention, devices can be arranged at particular positions in a map template that correspond to positions in a building in which the devices are located. Thus, it is possible to manage the devices using the map template.

Aspects of the present invention can be written as computer programs and can be implemented in general-use digital computers that execute the programs using a computer-readable recording medium. Also, structures of data used according to aspects of the present invention can be recorded on a recording medium using a variety of means. Examples of the computer-readable recording medium include magnetic storage media (e.g., ROM, floppy disks, hard disks, etc.), and optical recording media (e.g., CD-ROMs, or DVDs).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of creating a map template that represents an interior structure of a building in which devices are located, the method comprising:
displaying a menu of an application that manages the devices, the menu comprising a plurality of elements selectable to represent interior components of a general building;
displaying a user interface in the application, the user interface displaying a representation of the interior structure of the building in which the devices are located;
selecting one or more elements from the displayed menu to compose, in the user interface, the interior structure of the building in which the devices are located; and
arranging the selected elements at positions in the displayed user interface to correspond to the interior structure of the building.

2. The method as claimed in claim 1, wherein:
the plurality of elements of the menu comprise a plurality of selectable layouts that partition an inner space of the building and selectable figure images that represent the interior components of the general building; and
the elements are displayed as icons.

3. The method as claimed in claim 1, wherein the selecting of the one or more elements and the arranging of the selected elements are performed using a mouse.

4. An apparatus to create a map template that represents an interior structure of a building in which devices are located, the apparatus comprising:
a display unit to display a menu window of an application that manages the devices, the menu window comprising a plurality of elements selectable to represent interior components of a general building, and to display a user interface in the application that displays a representation of the interior structure of the building in which the devices are located; and
a map template creating unit to select one or more elements from the displayed menu window to compose, in the user interface, the interior structure of the building in which the device are located, and to arrange the selected elements at positions in the displayed user interface in order to create the map template corresponding to the interior structure of the building.

5. The apparatus as claimed in claim 4, wherein:
the plurality of elements of the menu window comprise a plurality of selectable layouts that partition an inner space of the building and selectable figure images that represent the interior components of the general building; and
the elements are displayed as icons.

6. A method of managing devices located in a building using a map template, the method comprising:
searching for one or more devices in the building to be managed;
selecting a map template that represents an interior structure of the building in which the one or more devices found as a result of the searching are located; and
arranging the one or more found devices at predetermined positions in the selected map template.

7. The method as claimed in claim 6, wherein the selecting of the map template comprises selecting the map template from a database that stores a plurality of map templates.

8. The method as claimed in claim 6, wherein the searching for the one or more devices comprises generating one or more groups to classify the one or more devices, and adding the one or more devices into corresponding groups.

9. The method as claimed in claim 8, wherein the selecting of the map template comprises selecting a map template that represents an interior structure corresponding to one of the groups into which the one or more devices are added.

10. The method as claimed in claim 6, wherein the predetermined positions in the map template correspond to positions in the building in which the one or more devices are located.

11. The method as claimed in claim 6, wherein the selecting of the map template comprises creating the map template that represents the interior structure of the building in which the one or more devices are located.

12. An apparatus to manage devices located in a building using a map template, the apparatus comprising:
a searching unit to search for one or more devices in the building to be managed;
a map template selecting unit to select a map template that represents an interior structure of the building in which the one or more devices found by the searching unit are located; and
a device managing unit to arrange the one or more found devices at predetermined position in the selected map template.

13. The apparatus as claimed in claim 12, further comprising:
a database which to store a plurality of map templates,
wherein the map template selecting unit selects the map template from the database.

14. The apparatus as claimed in claim 12, wherein the predetermined positions in the map template correspond to positions in the building in which the one or more devices are located.

15. The apparatus as claimed in claim 12, wherein the searching unit generates one or more groups to classify the one or more found devices, and adds the one or more found devices into corresponding groups.

16. The apparatus as claimed in claim 15, wherein the map template selecting unit selects a map template that represents an interior structure corresponding to one of the groups into which the one or more devices are added.

17. The apparatus as claimed in claim 15, further comprising a map template creating unit to create the map template that represents the interior structure of the building in which the one or more devices are located before the map template selecting unit selects the map template.

18. A method of managing devices located in a building using a map template, the method comprising:
searching for one or more devices in the building to be managed;
creating a map template that represents an interior structure of the building in which the found one or more devices are located; and
arranging the one or more found devices at predetermined positions in the selected map template.

19. The method as claimed in claim 18, wherein the creating of the map template comprises:
displaying a menu of an application that manages the one or more devices, the menu comprising a plurality of elements selectable to represent interior components of a general building;
displaying a user interface in the application, the user interface displaying a representation of the interior structure of the building in which the one or more devices are located;
selecting one or more elements from the displayed menu to compose, in the user interface, the interior structure of the building in which the devices are located; and
arranging the selected elements at positions in the displayed user interface to correspond to the interior structure of the building.
